(19) United States
(12) Patent Application Publication
(10) Pub. No.: US 2026/0254364 A1
(43) Pub. Date: Aug. 27, 2026

(54) STEP-DOWN TYPE PURE SINE WAVE VOLTAGE CONVERSION SOCKET

(71) Applicant: Dongguan Fukun Electrical Appliance Co., Ltd., Dongguan City (CN)

(72) Inventor: ZHAOKUN ZENG, Dongguan City (CN)

(21) Appl. No.: 19/539,297

(22) Filed: Feb. 13, 2026

(30) Foreign Application Priority Data
Dec. 17, 2024 (CN) 202411861233.0
Feb. 28, 2025 (CN) 202520352333.4

(51) Int. Cl. H02M 5/458; H02M 1/00; H02M 1/088; H02M 1/36; H02M 7/06; H02M 7/5387; H02M 7/5395

(52) U.S. Cl. CPC H02M 5/4585; H02M 1/007; H02M 1/088; H02M 1/36; H02M 7/06; H02M 7/53871; H02M 7/5395

(57) ABSTRACT

Disclosed is a step-down type pure sine wave voltage conversion socket. The socket includes an alternating current (AC) input module, a main control unit, an inverter bridge module, and a voltage and current feedback module. The AC input module is configured to receive and feed alternating current mains electricity to a rectifier and filter module. The main control unit generates a sinusoidal pulse width modulation (SPWM) signal to control an on-off state and a duty cycle of the inverter bridge module. The inverter bridge module includes a plurality of switching transistors, and the energy storage and filter module is configured to filter the pulse voltage into pure sine wave alternating current voltage and output the pure sine wave alternating current voltage through an AC terminal. The voltage and current feedback module is connected to an output end of the energy storage and filter module.

### CROSS-REFERENCE TO RELATED APPLICATIONS

The application claims priority of Chinese patent application 202411861233.0, filed on 12/17/2024, and Chinese patent application 202520352333.4, filed on 02/28/2025, which are incorporated herein by reference in their entireties.

### TECHNICAL FIELD

The present disclosure relates to the field of socket converters, and particularly relates to a step-down type pure sine wave voltage conversion socket.

### BACKGROUND

With the development of globalization and the popularity of international travel, increasing people cross national borders for business, tourism, or work. However, sockets and voltage standards used in different countries in the world vary from each other, bringing inconvenience to the use of electronic devices. At present, common voltages on the market are generally divided into 110 V and 220 V. When an electronic device is used in different countries, its incompatible plug or unmatched voltage will not only cause failure in normal charge or operation, but may even lead to device damage or safety accidents.

To solve the above problems, an AC TO AC square wave (or modified sine wave) step- down travel power strip is available on the market, but many devices cannot use square wave voltage. Further, an AC TO AC pure sine wave step-down travel power strip is also available. However, this kind of voltage conversion socket needs to rectify and filter mains electricity and then use a DC TO DC step-down circuit for voltage step-down, and then use an inverter bridge circuit to invert and change it into pure sine wave voltage output. Such sockets mostly achieve only 50 HZ, with complex circuits, high cost, and low efficiency.

In view of that, the inventor provides the following technical solution.

### SUMMARY

An objective of the present disclosure is to overcome defects in the prior art, and provide a step-down type pure sine wave voltage conversion socket.

To solve the above technical problems, the present disclosure uses the following technical solution: the step-down type pure sine wave voltage conversion socket includes an alternating current (AC) input module configured to receive and feed alternating current mains electricity to a rectifier and filter module, to rectify and filter the alternating current mains electricity into direct current; and further includes a main control unit, an inverter bridge module, and a voltage and current feedback module. The main control unit generates a sinusoidal pulse width modulation (SPWM) signal to control an on-off state and a duty cycle of the inverter bridge module, so as to cause the inverter bridge module to convert the direct current of the rectifier and filter module into pulse voltage and output the pulse voltage to an energy storage and filter module. The inverter bridge module includes a plurality of switching transistors. An input end of the inverter bridge module is connected to the rectifier and filter module, and an output end of the inverter bridge module is connected to the energy storage and filter module. An input end of the energy storage and filter module is connected to the inverter bridge module, and the energy storage and filter module is configured to filter the pulse voltage into pure sine wave alternating current voltage and output the pure sine wave alternating current voltage through an AC terminal. The voltage and current feedback module is connected to an output end of the energy storage and filter module, and is configured to detect output voltage and current and transmit a feedback signal to the main control unit. The main control unit adjusts the SPWM signal according to a feedback voltage and current signal, to stably output sine wave voltage.

Further, in the above technical solution, the switching transistors are any kind of bipolar junction transistors, metal-oxide semiconductor (MOS) transistors, insulated gate bipolar transistors (IGBTs), gallium nitride MOSs, and silicon carbide MOSs.

Further, in the above technical solution, the inverter bridge module includes an MOS transistor M1, an MOS transistor M2, an MOS transistor M3, and an MOS transistor M4. A gate (G) electrode of each of the MOS transistors is connected to a driver chip of the main control unit through a peripheral driver unit. After a main control chip of the main control unit sends the sinusoidal pulse width modulation (SPWM) signal, the four MOS transistors are driven to work to generate a sinusoidal pulse width modulation pulse voltage, and the sinusoidal pulse width modulation pulse voltage is filtered by the energy storage and filter module connected to the output end into the pure sine wave alternating current voltage.

Further, in the above technical solution, the inverter bridge module includes IGBT-M1, IGBT-M2, IGBT-M3, and IGBT-M4. A G electrode of each of the IGBTs is connected to a driver chip of the main control unit through a peripheral driver unit. After a main control chip of the main control unit sends the sinusoidal pulse width modulation (SPWM) signal, the four IGBTs are driven to work to generate a sinusoidal pulse width modulation pulse voltage, and the sinusoidal pulse width modulation pulse voltage is filtered by the energy storage and filter module connected to the output end into the pure sine wave alternating current voltage.

Further, in the above technical solution, the driver unit includes a first driver module connecting the IGBT-M1 to an energy storage and filter module, a second driver module connecting the IGBT-M2 to the energy storage and filter module, a third driver module connecting the IGBT-M3 to the energy storage and filter module, and a fourth driver module connecting the IGBT-M4 to the energy storage and filter module.

Further, in the above technical solution, the first driver module includes a resistor R3, a diode D1, and a resistor R9 that are connected in parallel to the G electrode of the IGBT-M1. The other ends of the resistor R3 and the diode D1 are connected to a pin HO-1 of the main control unit. The resistor R9 and a source (S) electrode of the IGBT-M1 are connected to a pin N-OUT of the energy storage and filter module and a drain (D) electrode of the IGBT-M3. A D electrode of the IGBT-M1 is connected to the rectifier and filter module. The third driver module has an identical structure to the first driver module. The third driver module is connected to a pin LO-1 of the main control unit.

Further, in the above technical solution, the second driver module includes a resistor R7 and a resistor R8 that are connected in series between the G electrode of the IGBT-M1 and a pin HO-2 of the main control unit, a diode D4 connected in parallel to the resistor R8, and a resistor R12 connected between the G electrode of the IGBT-M1 and a pin VS2 of the main control unit. A D electrode of the IGBT-M2 is connected to the rectifier and filter module. An S electrode of the IGBT-M2 is connected to the pin VS2 of the main control unit, an inductor L1 of the energy storage and filter module, and a D electrode of the IGBT-M4. The fourth driver module has an identical structure to the second driver module. The fourth driver module is connected to a pin LO-1 of the main control unit.

Further, in the above technical solution, the energy storage and filter module includes an inductor L1 and a capacitor C12 that are connected to the inverter bridge module and the AC terminal, and is configured to filter sinusoidal pulse width modulation pulse voltage generated by the inverter bridge module into the pure sine wave alternating current voltage.

Further, in the above technical solution, the step-down type pure sine wave voltage conversion socket further includes a direct current (DC) power supply circuit and a universal serial bus (USB) charging module. The DC power supply circuit includes DC12V and DC5V. The DC12V is configured to supply power to the driver chip of the main control unit. The DC5V is configured to supply power to the main control chip of the main control unit.

Further, in the above technical solution, the USB charging module includes a fuse F3, a power main control chip U2, a transformer TI, a power controller U6, a synchronous step-down converter U9, a first USB unit, a second USB unit, a third USB unit, and a fourth USB unit. The fuse F3 is connected to the rectifier and filter module. The DC power supply circuit is connected to a pin VCC of the power main control chip U2. The first USB unit and the second USB unit are TYPE-C output interfaces.

Further, in the above technical solution, the DC power supply circuit includes an MOS transistor M5 and a chip U1 that are connected in series to the USB charging module and the main control unit, a capacitor C9 connected between a pin IN and a pin GND of the chip U1, a capacitor C17 connected between a pin OUT and the pin GND of the chip U1, a capacitor C19 connected between a D electrode and a G electrode of the MOS transistor M5, and a capacitor C20 and a capacitor C16 that are connected in parallel to an S electrode and the G electrode of the MOS transistor M5. The S electrode of the MOS transistor M5 is connected to the pin IN of the chip U1 and connected to +12 V voltage. The D electrode of the MOS transistor M5 is connected to the pin VCC of the USB charging module. The G electrode of the MOS transistor M5 is connected to a pin HGND. The pin GND of the chip U1 is connected to the pin HGND. The pin OUT of the chip U1 is connected to AC-5V. The DC12V is configured to supply power to the driver chip of the main control unit. The DC5V is configured to supply power to the main control chip of the main control unit.

Further, in the above technical solution, the step-down type pure sine wave voltage conversion socket further includes a negative temperature coefficient (NTC) temperature measurement circuit. The NTC temperature measurement circuit includes a capacitor C14, a capacitor C15, a resistor R15, a resistor R17, and a resistor R18. The resistor R17 is an NTC temperature measurement resistor and is connected to a pin AC-5V. The resistor R15, the capacitor C14 and the resistor R18 are connected in parallel to one end of the resistor R17. The capacitor C15 is connected between the capacitor C14, the resistor R15 and the resistor R18, one end of the capacitor C15 is connected to a pin TFB of the main control chip, and the other end of the capacitor C15 is connected to a pin HGND.

Further, in the above technical solution, the step-down type pure sine wave voltage conversion socket further includes a touch module. The touch module outputs high and low levels to control the main control unit to be turned on and off. When a device is in an off state, a touch switch is touched, a touch integrated circuit (IC) sends a high level to the main control unit, and the main control unit generates output of the sinusoidal pulse width modulation (SPWM) signal to drive an inverter bridge circuit to work, so as to cause an output AC socket to generate alternating current voltage output. The touch switch is re-touched, the touch IC sends a low level to the main control unit, the main control unit disables the sinusoidal pulse width modulation (SPWM) signal, the inverter bridge circuit stops working, and the output AC socket generates no output voltage.

Further, in the above technical solution, the voltage and current feedback module includes an output voltage detection module connected to the energy storage and filter module and an output current detection module connected to the inverter bridge module.

Further, in the above technical solution, the output voltage detection module includes a resistor R38, a resistor R39 and a resistor R40 that are connected in series to a pin L-OUT, and a resistor R41 and a capacitor C25 that are connected in parallel to the resistor R40. The other ends of the resistor R40, the resistor R41 and the capacitor C25 are connected to the main control unit.

Further, in the above technical solution, the output current detection module includes a resistor R30, a resistor R31, a resistor R32 and a resistor R27 that are connected in parallel to an S electrode of the IGBT-M3 and an S electrode of the IGBT-M4, and a capacitor C24 and a resistor R25 that are connected in parallel to the resistor R27.

Further, in the above technical solution, the main control unit further includes a fan control module. The fan control module includes a resistor R29, a resistor R35, a resistor R66, a resistor R67, an optical coupler P2, an MOS transistor M6, and a fan F2. A resistor R44 and a resistor R46 are connected in series to a pin FANCTR of the main control chip. One end of the resistor R46 is connected to a pin HGND. An optical coupler P2B is connected in parallel to the resistor R35.

Further, in the above technical solution, a D electrode of the MOS transistor M6 and an optical coupler P2A are connected to two ends of the fan F2, respectively. The resistor R66 is connected between a G electrode of the MOS transistor M6 and the optical coupler P2A. The resistor R67 is connected to the G electrode of the MOS transistor M6 and grounded. An S electrode of the MOS transistor M6 is grounded.

Through the above technical solution, compared with the prior art, the present disclosure h s the following beneficial effects: the present disclosure reduces a front-end DC TO DC step- down circuit and adjusts the sinusoidal pulse width modulation (SPWM) signal to control a duty cycle through the inverter bridge module, so as to implement direct step-down of DC TO AC. In this way, components and costs are reduced, and efficiency is improved.

### BRIEF DESCRIPTION OF DRAWING(S)

FIG. 1 is an overall circuit diagram of an energy storage and filter module using Embodiment 1 in the present disclosure;

FIG. 2 is a partial circuit diagram 1 of the Embodiment 1 in the present disclosure;

FIG. 3 is a partial circuit diagram 2 of the Embodiment 1 in the present disclosure;

FIG. 4 is a partial circuit diagram 3 of the Embodiment 1 in the present disclosure;

FIG. 5 is an overall circuit diagram of an energy storage and filter module using Embodiment 2 in the present disclosure;

FIG. 6 is a partial circuit diagram 1 of the Embodiment 2 in the present disclosure;

FIG. 7 is a partial circuit diagram 2 of the Embodiment 2 in the present disclosure;

FIG. 8 is a partial circuit diagram 3 of the Embodiment 2 in the present disclosure;

FIG. 9 is a circuit diagram of a main control unit in the present disclosure;

FIG. 10 is a partial circuit diagram 1 of the main control unit in the present disclosure;

FIG. 11 is a partial circuit diagram 2 of the main control unit in the present disclosure;

FIG. 12 is a circuit diagram of a universal serial bus (USB) charging module in the present disclosure;

FIG. 13 is a partial circuit diagram 1 of the USB charging module in the present disclosure;

FIG. 14 is a partial circuit diagram 2 of the USB charging module in the present disclosure;

FIG. 15 is a partial circuit diagram 3 of the USB charging module in the present disclosure:

FIG. 16 is a partial circuit diagram 4 of the USB charging module in the present disclosure;

FIG. 17 is a partial circuit diagram 5 of the USB charging module in the present disclosure;

FIG. 18 is a partial circuit diagram 6 of the USB charging module in the present disclosure;

FIG. 19 is a circuit diagram of a direct current (DC) power supply circuit in the present disclosure;

FIG. 20 is a circuit diagram of an output voltage detection module in the present disclosure; and

FIG. 21 is a circuit diagram of a negative temperature coefficient (NTC) temperature measurement module in the present disclosure.

### DETAILED DESCRIPTION

The present disclosure will be further described below with reference to specific embodiments and accompanying drawings.

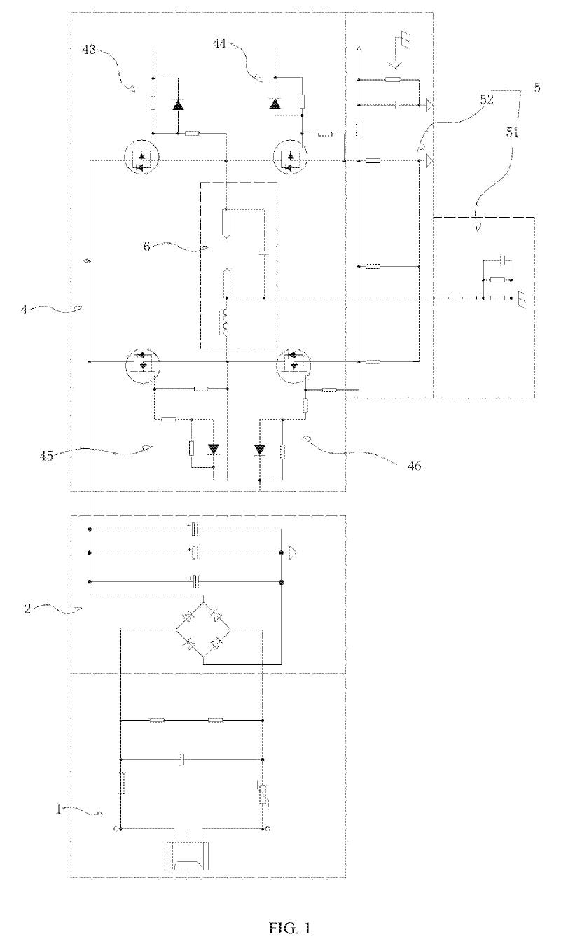

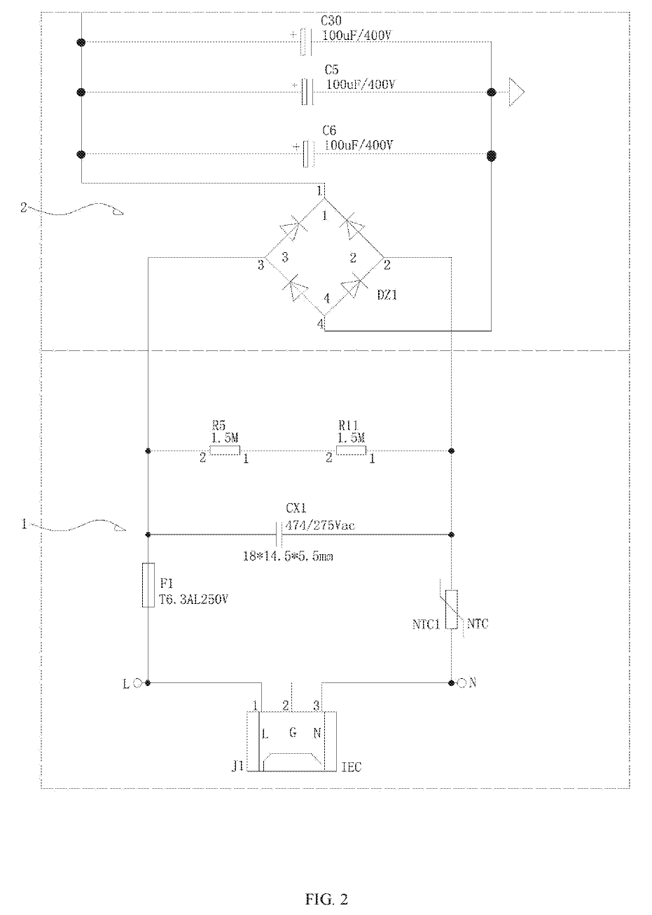

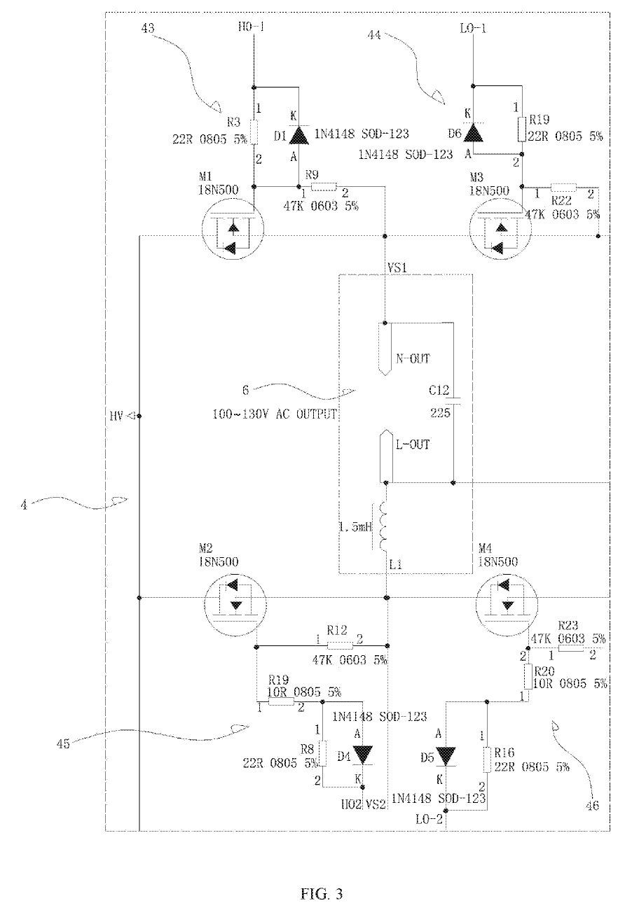

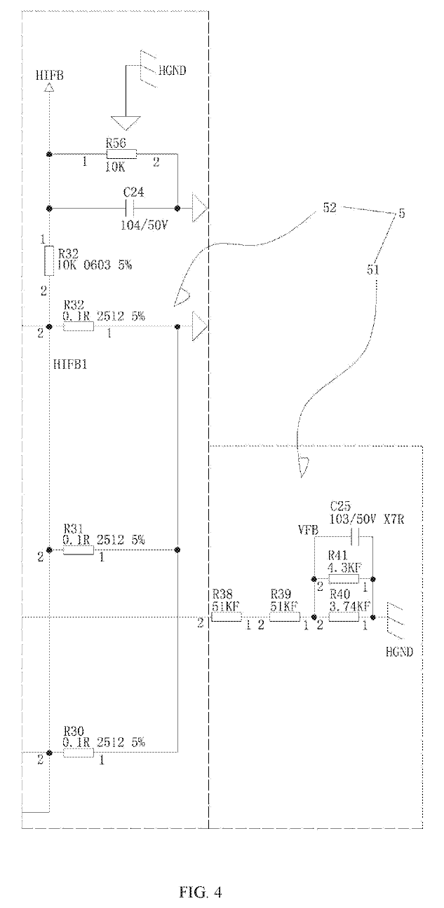

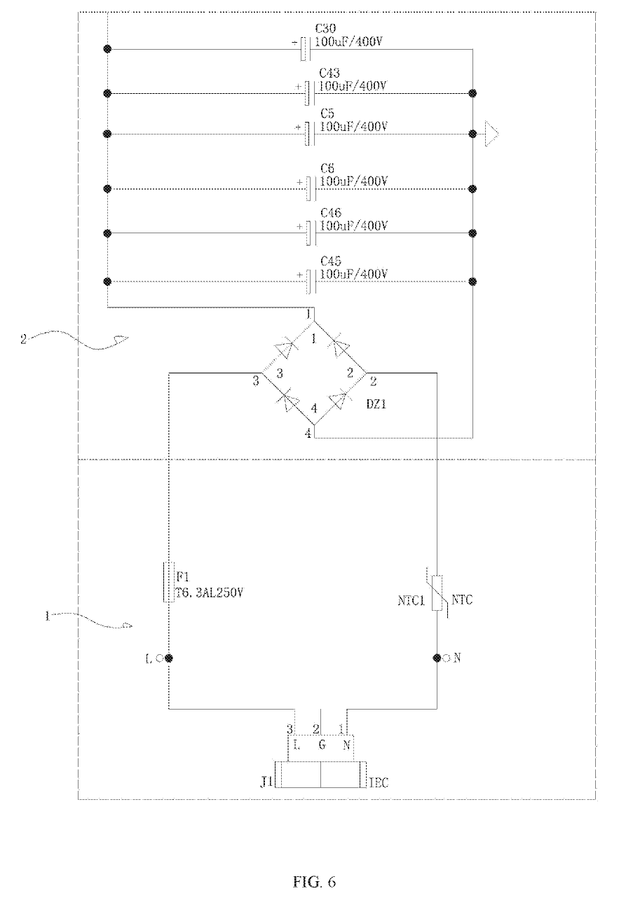

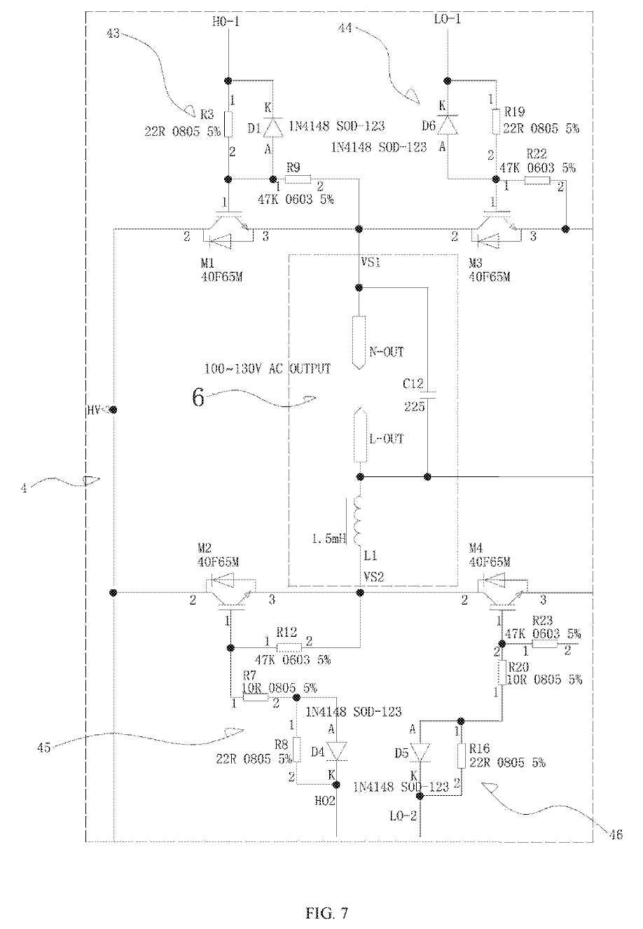

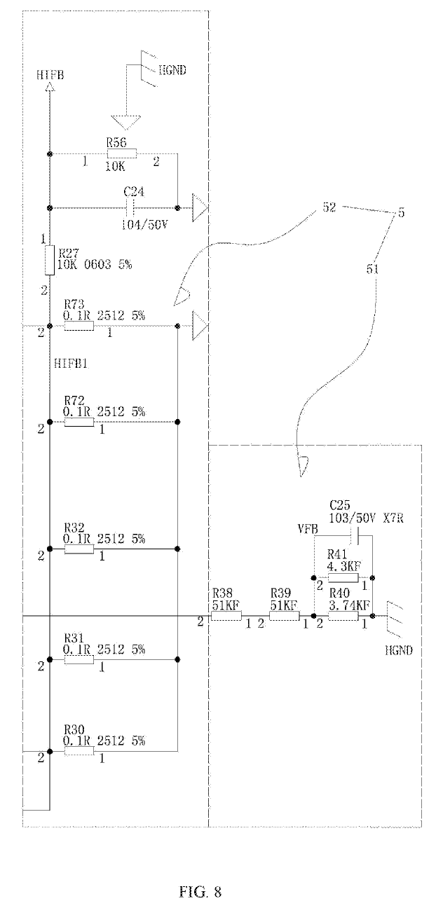

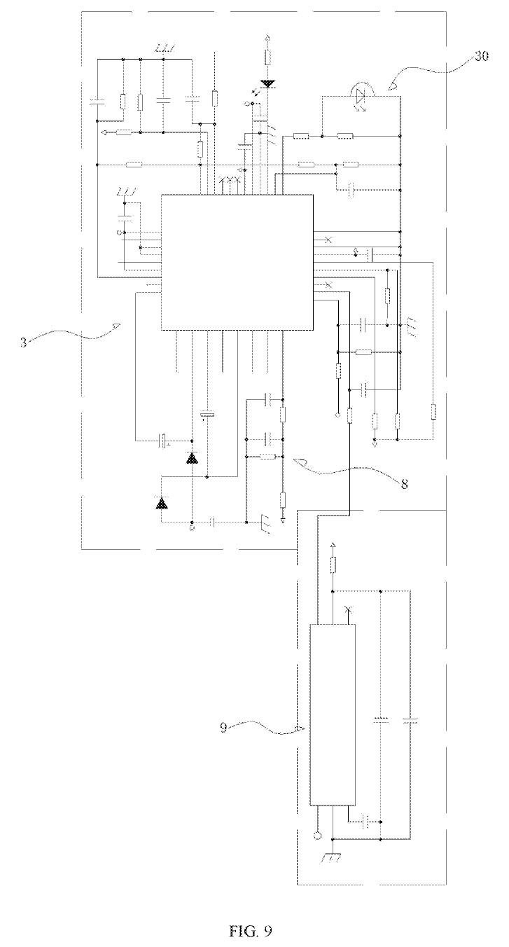

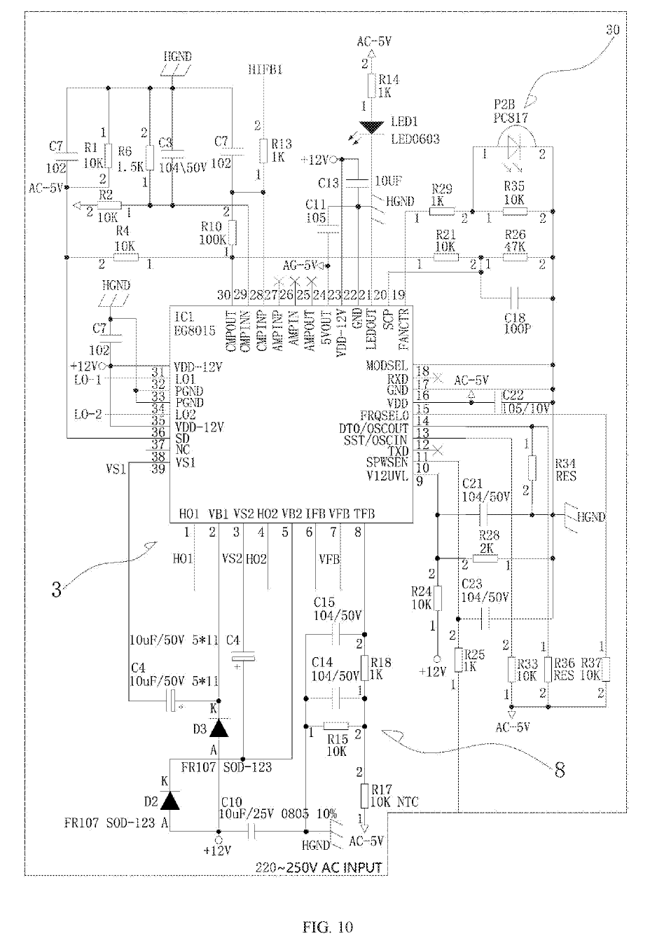

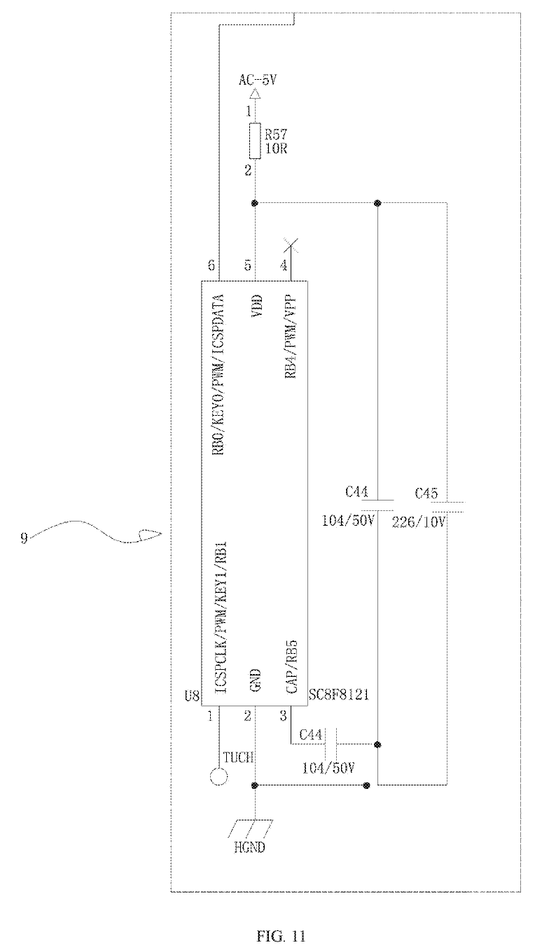

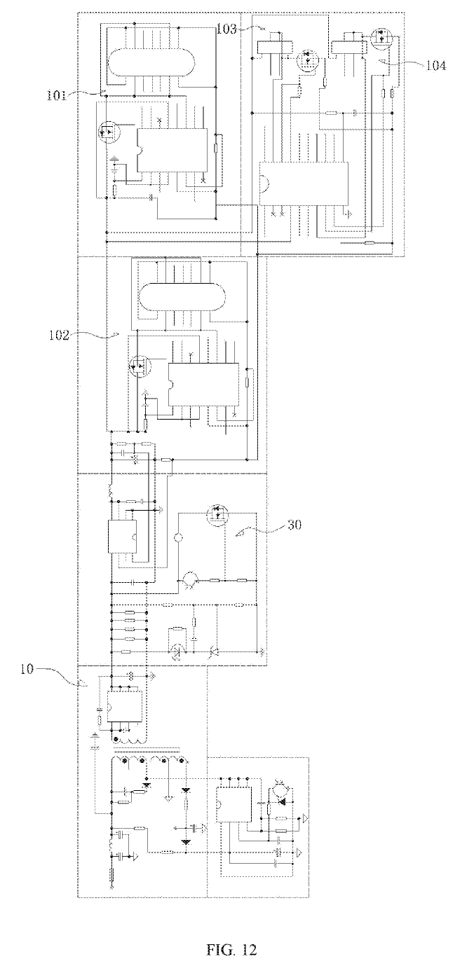

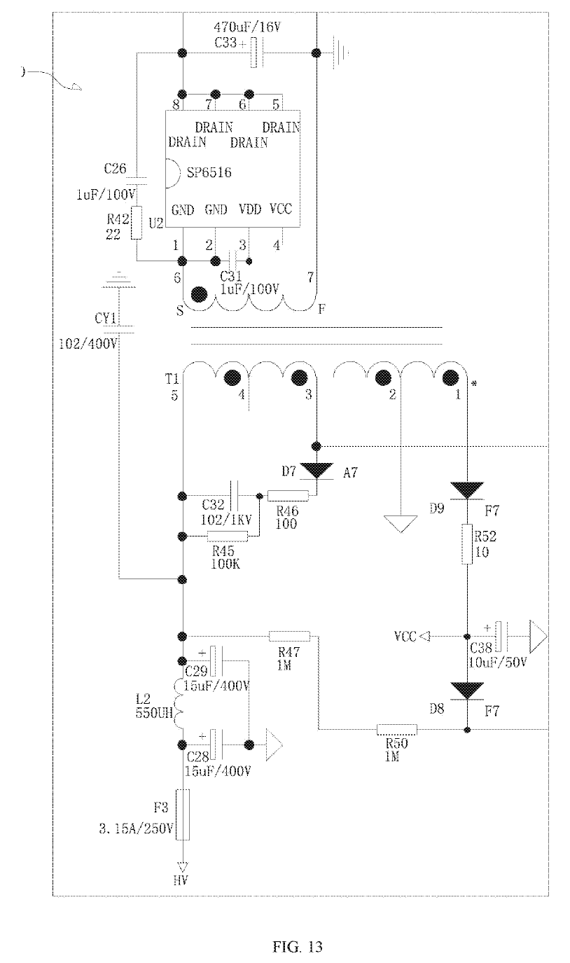

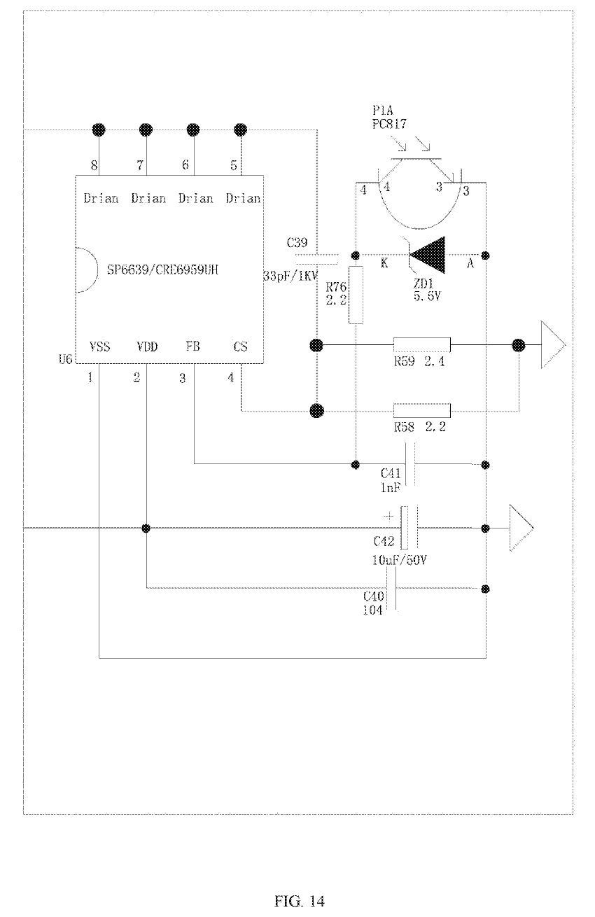

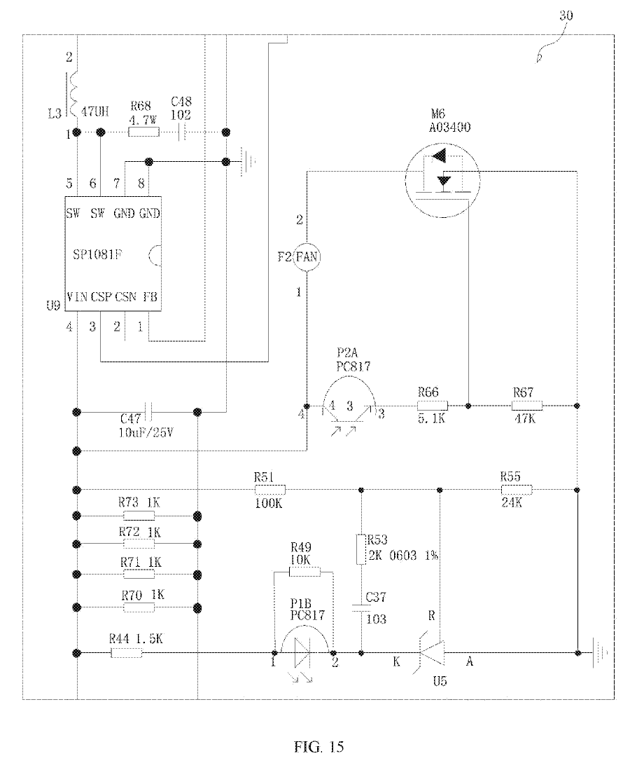

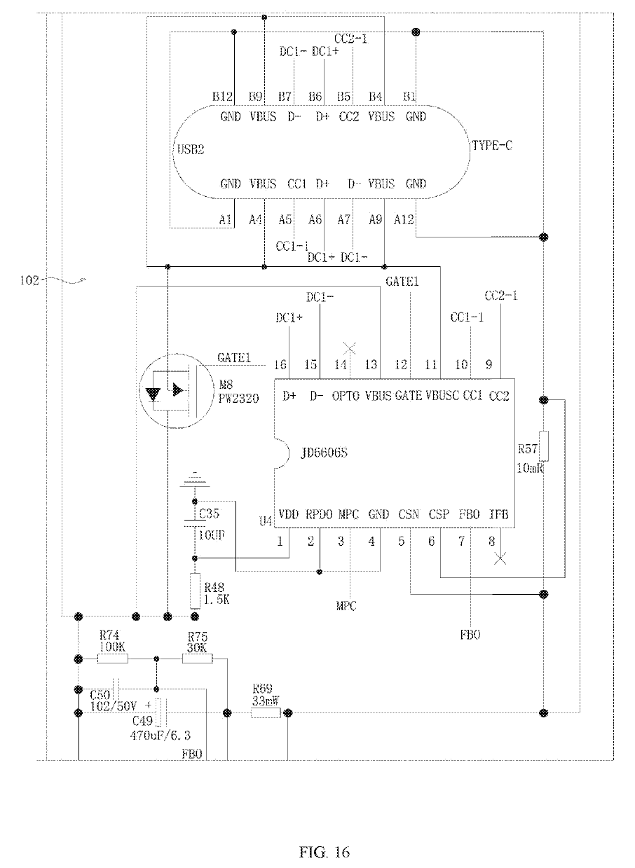

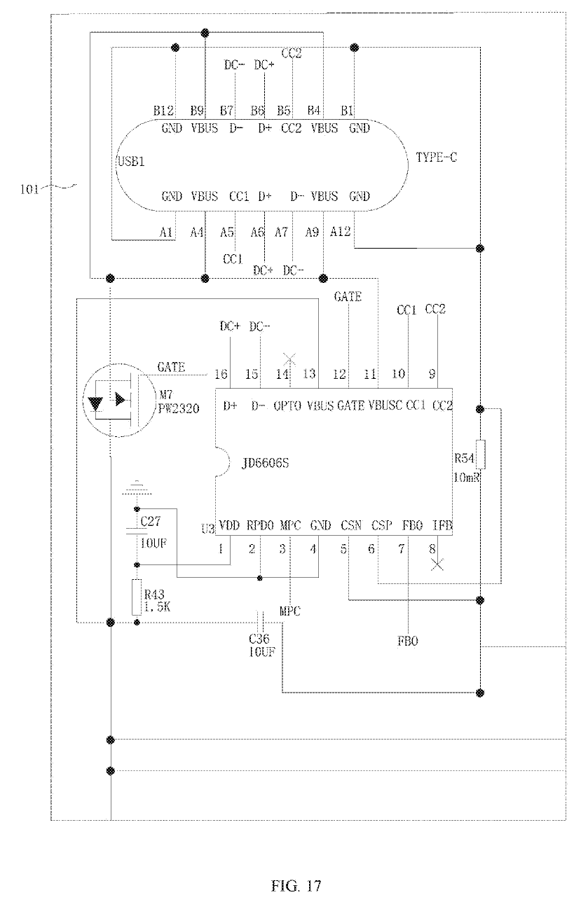

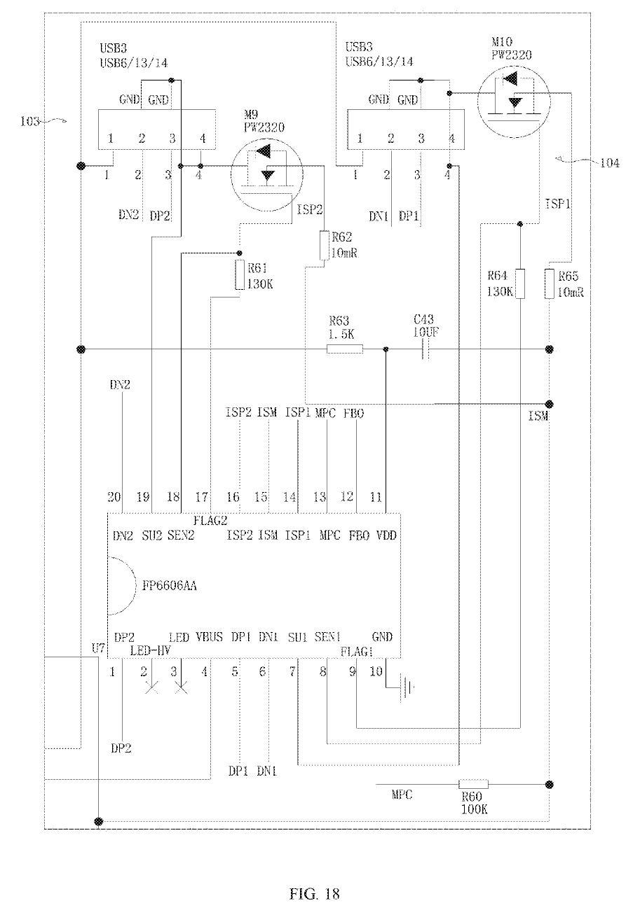

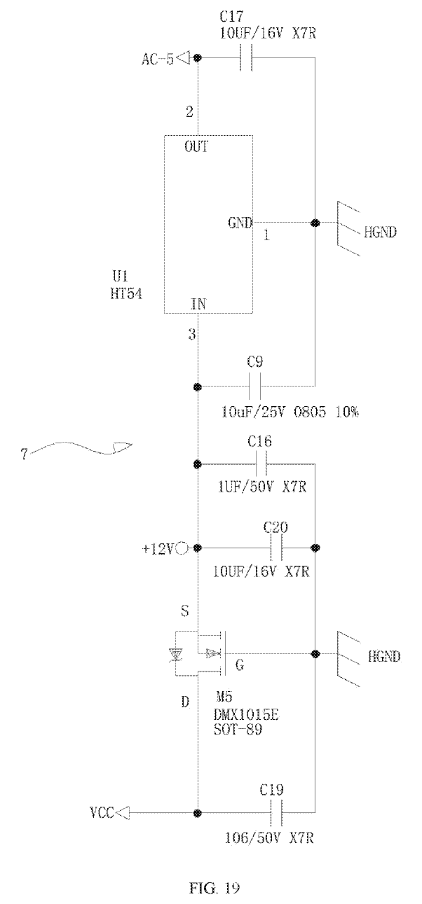

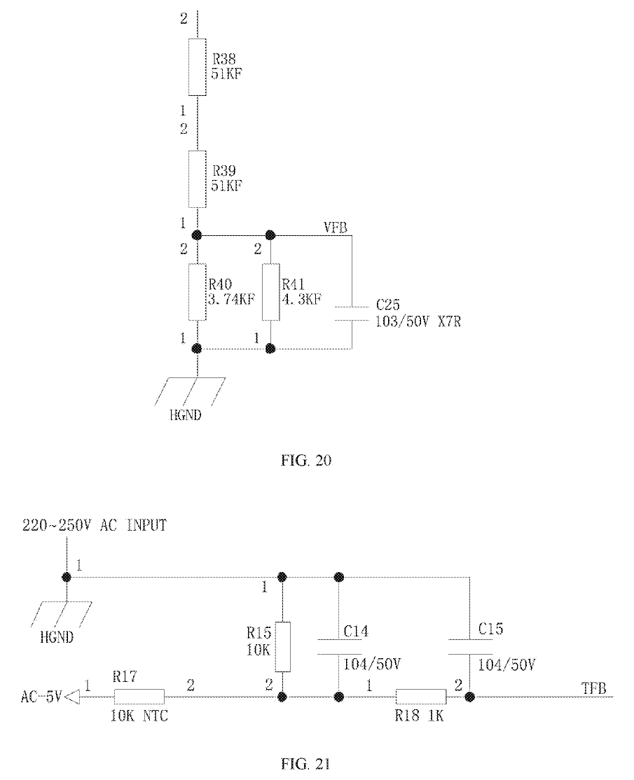

As shown in FIGS. 1 to FIG. 21, a step-down type pure sine wave voltage conversion socket includes an alternating current (AC) input module 1, a main control unit 3, an inverter bridge module 4, and a voltage and current feedback module 5. The AC input module 1 is configured to receive and feed alternating current mains electricity to a rectifier and filter module 2, to rectify and filter the alternating current mains electricity into direct current. The main control unit 3 generates a sinusoidal pulse width modulation (SPWM) signal to control an on-off state and a duty cycle of the inverter bridge module 4, so as to cause the inverter bridge module 4 to convert the direct current of the rectifier and filter module 2 into pulse voltage and output the pulse voltage to an energy storage and filter module 6. The inverter bridge module 4 includes a plurality of switching transistors. An input end of the inverter bridge module is connected to the rectifier and filter module 2, and an output end of the inverter bridge module is connected to the energy storage and filter module 6. An input end of the energy storage and filter module 6 is connected to the inverter bridge module 4, and the energy storage and filter module is configured to filter the pulse voltage into pure sine wave alternating current voltage and output the pure sine wave alternating current voltage through an AC terminal. The voltage and current feedback module 5 is connected to an output end of the energy storage and filter module 6, and is configured to detect output voltage and current and transmit a feedback signal to the main control unit 3. The main control unit 3 adjusts the SPWM signal according to a feedback voltage and current signal, to stably output sine wave voltage. The switching transistors include, but are not limited to, any kind of bipolar junction transistors, metal-oxide semiconductor (MOS) transistors, insulated gate bipolar transistors (IGBTs), gallium nitride MOSs, and silicon carbide MOSs.

As shown in FIGS. 1 to FIG. 4, in Embodiment 1, the inverter bridge module 4 includes an MOS transistor M1, an MOS transistor M2, an MOS transistor M3, and an MOS transistor M4. A gate (G) electrode of each of the MOS transistors is connected to a driver chip of the main control unit 3 through a peripheral driver unit. After a main control chip of the main control unit 3 sends the sinusoidal pulse width modulation (SPWM) signal, the four MOS transistors are driven to work to generate a sinusoidal pulse width modulation pulse voltage, and the sinusoidal pulse width modulation pulse voltage is filtered by the energy storage and filter module 6 connected to the output end into the pure sine wave alternating current voltage. The driver unit includes a first driver module 43 connecting the MOS transistor M1 to an energy storage and filter module 6, a second driver module 44 connecting the MOS transistor M2 to the energy storage and filter module 6, a third driver module 45 connecting the MOS transistor M3 to the energy storage and filter module 6, and a fourth driver module 46 connecting the MOS transistor M4 to the energy storage and filter module 6.

The rectifier and filter module 2 is used for converting AC input into direct current (DC) so as to be sent to the inverter bridge module 4. The inverter bridge module 4 composed of the MOS transistor M1, the MOS transistor M2, the MOS transistor M3 and the MOS transistor M4 converts the DC into AC output. The MOS transistor M2, the MOS transistor M3 and the MOS transistor M4 form a group of switches, when the MOS transistor M2 and the MOS transistor M3 work, the MOS transistor M1 does not work, an SPWM 20 KHz drive signal width-adjusted by the main control unit 3 is sent to the switching transistor of the MOS transistor M2 to drive the switch of the MOS transistor M2 to work, when the MOS transistor M2 is turned off, the MOS transistor M4 is turned on to provide a freewheeling channel for an inductor L1, the switching transistor of the MOS transistor M3 is continuously turned on, a duty cycle of an SPWM switching waveform increases from low to high, increases to a top of a sine wave, and then decreases from high to low, direct current high voltage (HV) is transmitted from the switching transistor of the MOS transistor M2 to an energy storage and filter network composed of the inductor L1 and a capacitor C12, and the energy storage and filter network composed of the inductor L1 and the capacitor C12 converts switching pulse sent by the MOS transistor M2 into a positive half-cycle sine wave waveform. Meanwhile, the switching transistors of the MOS transistor M1, the MOS transistor M4 and the MOS transistor M2 form a negative half-cycle of the sine wave, the SPWM 20 KHz drive waveform width-adjusted by the main control unit 3 drives the switching transistor of the MOS transistor M4 to work, the MOS transistor M3 does not work, when the MOS transistor M4 is turned off, the MOS transistor M2 is turned on to provide a freewheeling channel for the inductor L1, the switching transistor of the MOS transistor M1 is continuously turned on, a duty cycle of the SPWM switching waveform increases from low to high, increases to the top of the sine wave, and then decreases from high to low, the direct current high voltage (HV) is transmitted from the switching transistor of the MOS transistor M1 to the energy storage and filter network composed of the inductor L1 and the capacitor C12, and the energy storage and filter network composed of the inductor L1 and the capacitor C12 converts switching pulse sent by the MOS transistor M1 into a negative half-cycle sine wave waveform. In the process, the SPWM pulse sent by the switching transistor is filtered into the sine wave through the energy storage and filter network composed of the inductor L1 and the capacitor C12.

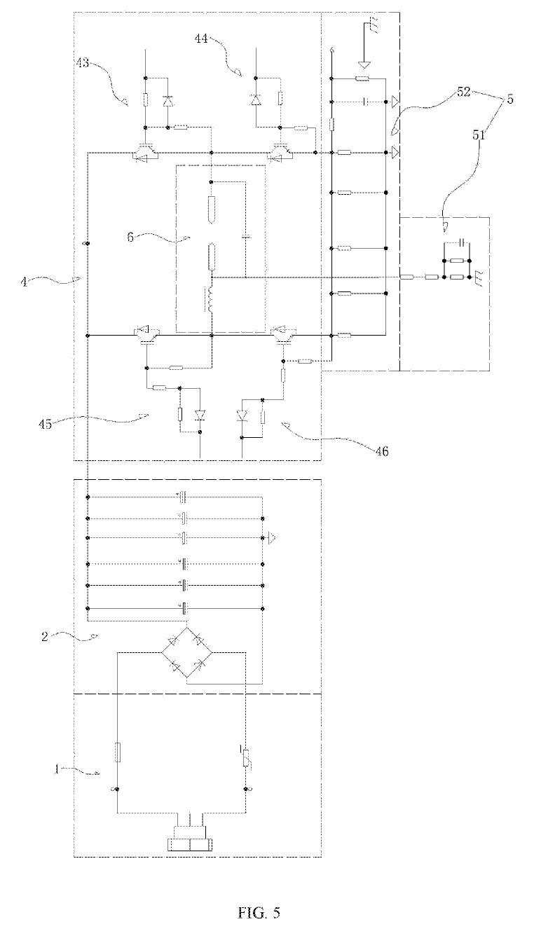

As shown in FIGS. 5 to FIG. 8, in Embodiment 2, the inverter bridge module 4 includes IGBT-M1, IGBT-M2, IGBT-M3, and IGBT-M4. A G electrode of each of the IGBTs is connected to a driver chip of the main control unit 3 through a peripheral driver unit. After a main control chip of the main control unit 3 sends the sinusoidal pulse width modulation (SPWM) signal, the four IGBTs are driven to work to generate a sinusoidal pulse width modulation pulse voltage, and the sinusoidal pulse width modulation pulse voltage is filtered by the energy storage and filter module 6 connected to the output end into the pure sine wave alternating current voltage. The driver unit includes a first driver module 43 connecting the IGBT-M1 to an energy storage and filter module 6, a second driver module 44 connecting the IGBT-M2 to the energy storage and filter module 6, a third driver module 45 connecting the IGBT-M3 to the energy storage and filter module 6, and a fourth driver module 46 connecting the IGBT-M4 to the energy storage and filter module 6.

The rectifier and filter module 2 is used for converting the AC input into the DC so as to be sent to the inverter bridge module 4. The inverter bridge module 4 composed of the IGBT-M1, the IGBT-M2, the IGBT-M3 and the IGBT-M4 converts the DC into the AC output. The IGBT-M2, the IGBT-M3 and the IGBT-M4 form a group of switches, when the IGBT-M2 and the IGBT-M3 work, the IGBT-M1 does not work, the SPWM 20 KHz drive signal width- adjusted by the main control unit 3 is sent to the switching transistor of the IGBT-M2 to drive the switch of the IGBT-M2 to work, when the IGBT-M2 is turned off, the IGBT-M4 is turned on to provide a freewheeling channel for the inductor L1, the switching transistor of the IGBT-M3 is continuously turned on, the duty cycle of the SPWM switching waveform increases from low to high, increases to the top of the sine wave, and then decreases from high to low, the direct current high voltage (HV) is transmitted from the switching transistor of the IGBT-M2 to an energy storage and filter network composed of the inductor L1 and the capacitor C12, and the energy storage and filter network composed of the inductor L1 and the capacitor C12 converts switching pulse sent by the IGBT-M2 into a positive half-cycle sine wave waveform. Meanwhile, the switching transistors of the IGBT-M1, the IGBT-M4 and the IGBT-M2 form a negative half- cycle of the sine wave, the SPWM 20 KHz drive waveform width-adjusted by the main control unit 3 drives the switching transistor of the IGBT-M4 to work, the IGBT-M3 does not work, when the IGBT-M4 is turned off, the IGBT-M2 is turned on to provide the freewheeling channel for the inductor L1, the switching transistor of the IGBT-M1 is continuously turned on, the duty cycle of the SPWM switching waveform increases from low to high, increases to the top of the sine wave, and then decreases from high to low, the direct current high voltage (HV) is transmitted from the switching transistor of the IGBT-M1 to the energy storage and filter network composed of the inductor L1 and the capacitor C12, and the energy storage and filter network composed of the inductor L1 and the capacitor C12 converts switching pulse sent by the IGBT-M1 into the negative half-cycle sine wave waveform. In the process, the SPWM pulse sent by the switching transistor is filtered into the sine wave through the energy storage and filter network composed of the inductor L1 and the capacitor C12.

The IGBT-M1 is used as the switching transistor in the inverter bridge module 4 for specific implementation as follows:

The first driver module 43 includes a resistor R3, a diode D1, and a resistor R9 that are connected in parallel to the G electrode of the IGBT-M1. The other ends of the resistor R3 and the diode D1 are connected to a pin HO-1 of the main control unit 3. The resistor R9 and a source (S) electrode of the IGBT-M1 are connected to a pin N-OUT of the energy storage and filter module 6 and a drain (D) electrode of the IGBT-M3. A D electrode of the IGBT-M1 is connected to the rectifier and filter module 2. The third driver module 45 has an identical structure to the first driver module 43. The third driver module 45 is connected to a pin LO-1 of the main control unit 3. The second driver module 44 includes a resistor R7 and a resistor R8 that are connected in series between the G electrode of the IGBT-M1 and a pin HO-2 of the main control unit 3, a diode D4 connected in parallel to the resistor R8, and a resistor R12 connected between the G electrode of the IGBT-M1 and a pin VS2 of the main control unit 3. A D electrode of the IGBT-M2 is connected to the rectifier and filter module 2. An S electrode of the IGBT-M2 is connected to the pin VS2 of the main control unit 3, an inductor L1 of the energy storage and filter module 6, and a D electrode of the IGBT-M4. The fourth driver module 46 has an identical structure to the second driver module 44. The fourth driver module 46 is connected to a pin LO-1 of the main control unit 3.

In an embodiment, the energy storage and filter module 6 includes an inductor L1 and a capacitor C12 that are connected to the inverter bridge module 4 and the AC terminal, and is configured to filter sinusoidal pulse width modulation pulse voltage generated by the inverter bridge module 4 into the pure sine wave alternating current voltage.

In an embodiment, the step-down type pure sine wave voltage conversion socket further includes a direct current (DC) power supply circuit 7. The DC power supply circuit 7 includes an MOS transistor MS and a chip U1 that are connected in series to a universal serial bus (USB) charging module 10 and the main control unit 3, a capacitor C9 connected between a pin IN and a pin GND of the chip U1, a capacitor C17 connected between a pin OUT and the pin GND of the chip U1, a capacitor C19 connected between a D electrode and a G electrode of the MOS transistor M5, and a capacitor C20 and a capacitor C16 that are connected in parallel to an S electrode and the G electrode of the MOS transistor M5. The S electrode of the MOS transistor MS is connected to the pin IN of the chip U1 and connected to +12 V voltage. The D electrode of the MOS transistor MS is connected to the pin VCC of the USB charging module 10. The G electrode of the MOS transistor MS is connected to a pin HGND. The pin GND of the chip U1 is connected to the pin HGND. The pin OUT of the chip U1 is connected to AC-SV. The DC12V is configured to supply power to the driver chip of the main control unit 3. The DC5V is configured to supply power to the main control chip of the main control unit 3.

In an embodiment, the step-down type pure sine wave voltage conversion socket further includes a negative temperature coefficient (NTC) temperature measurement circuit 8 configured to detect a temperature of a heating device and provide a basis for over-temperature protection of the device. The NTC temperature measurement circuit 8 includes a capacitor C14, a capacitor C15, a resistor R15, a resistor R17, and a resistor R18. The resistor R17 is an NTC temperature measurement resistor and is connected to a pin AC-5V. The resistor R15, the capacitor C14 and the resistor R18 are connected in parallel to one end of the resistor R17. The capacitor C15 is connected between the capacitor C14, the resistor R15 and the resistor R18, one end of the capacitor C15 is connected to a pin TFB of the main control chip, and the other end of the capacitor C15 is connected to a pin HGND.

In an embodiment, the step-down type pure sine wave voltage conversion socket further includes a touch module 9. The touch module 9 outputs high and low levels to control the main control unit 3 to be turned on and off. When a device is in an off state, a touch switch is touched, a touch integrated circuit (IC) sends a high level to the main control unit 3, and the main control unit 3 generates output of the sinusoidal pulse width modulation (SPWM) signal to drive an inverter bridge circuit to work, so as to cause an output AC socket to generate alternating current voltage output. The touch switch is re-touched, the touch IC sends a low level to the main control unit 3, the main control unit 3 disables the sinusoidal pulse width modulation (SPWM) signal, the inverter bridge circuit stops working, and the output AC socket generates no output voltage.

In an embodiment, the step-down type pure sine wave voltage conversion socket further includes the USB charging module 10. The USB charging module 10 includes a fuse F3, a power main control chip U2, a transformer TI, a power controller U6, a synchronous step-down converter U9, a first USB unit 101, a second USB unit 102, a third USB unit 103, and a fourth USB unit 104. The fuse F3 is connected to the rectifier and filter module 2. The DC power supply circuit 7 is connected to a pin VCC of the power main control chip U2. The first USB unit 101 and the second USB unit 102 are TYPE-C output interfaces.

In an embodiment, the voltage and current feedback module 5 includes an output voltage detection module 51 connected to the energy storage and filter module 6 and an output current detection module 52 connected to the inverter bridge module 4. The output voltage detection module 51 includes a resistor R38, a resistor R39 and a resistor R40 that are connected in series to a pin L-OUT, and a resistor R41 and a capacitor C25 that are connected in parallel to the resistor R40. The other ends of the resistor R40, the resistor R41 and the capacitor C25 are connected to the main control unit 3. The output current detection module 52 includes a resistor R30, a resistor R31, a resistor R32 and a resistor R27 that are connected in parallel to an S electrode of the IGBT-M3 and an S electrode of the IGBT-M4, and a capacitor C24 and a resistor R25 that are connected in parallel to the resistor R27.

The main control unit 3 further includes a fan control module 30. The fan control module 30 includes a resistor R29, a resistor R35, a resistor R66, a resistor R67, an optical coupler P2, an MOS transistor M6, and a fan F2. A resistor R44 and a resistor R46 are connected in series to a pin FANCTR of the main control chip. One end of the resistor R46 is connected to a pin HGND. An optical coupler P2B is connected in parallel to the resistor R35. A D electrode of the MOS transistor M6 and an optical coupler P2A are connected to two ends of the fan F2, respectively. The resistor R66 is connected between a G electrode of the MOS transistor M6 and the optical coupler P2A. The resistor R67 is connected to the G electrode of the MOS transistor M6 and grounded. An S electrode of the MOS transistor M6 is grounded.

To sum up, a working principle of the present disclosure is as follows:

During operation, alternating current mains electricity is subjected to fuse NTC surge protection through an AC input module 1 and then input, rectified by a DB 1 bridge rectifier, filtered by a capacitor C5, a capacitor C6 and a capacitor C30, and converted into smooth direct current high voltage (HV) so as to be sent to a full-bridge DC-AC inverter circuit composed of IGBT-M1, IGBT-M2, IGBT-M3, IGBT-M4, an inductor L1 and a capacitor C12.

Further, a main control unit 3 generates a 20 KHz SPWM waveform to drive the four IGBTs of the IGBT-M1, the IGBT-M2, the IGBT-M3 and the IGBT-M4 to work alternately.

Further, the IGBT-M2, the IGBT-M3 and the IGBT-M4 form a group of switches. An SPWM 20 KHz drive signal width-adjusted by the main control unit 3 is sent to a switching transistor of the IGBT-M2 to drive a switch of the IGBT-M2 to work. A switching transistor of the IGBT-M3 is continuously turned on, and the IGBT-M1 is not turned on. When the IGBT-M2 is turned off, the IGBT-M4 is turned on to provide a freewheeling channel for the inductor L1. A duty cycle of an SPWM switching waveform increases from low to high, increases to a top of a sine wave, and then decreases from high to low. The direct current high voltage (HV) is transmitted from the switching transistor of the IGBT-M2 to an energy storage and filter network composed of the inductor Li and the capacitor C12. The energy storage and filter network composed of the inductor L1 and the capacitor C12 converts switching pulse sent by the IGBT- M2 into a positive half-cycle sine wave waveform.

Further, the switching transistors of the IGBT-M1, the IGBT-M4 and the IGBT- M2 form a negative half-cycle of the sine wave. An SPWM 20 KHz drive waveform width- adjusted by the main control unit 3 drives the switching transistor of the IGBT-M4 to work. The IGBT-M3 does not work. When the IGBT-M4 is turned off, the IGBT-M2 is turned on to provide the freewheeling channel for the inductor L1. The switching transistor of the IGBT-M1 is continuously turned on. The duty cycle of the SPWM switching waveform increases from low to high, increases to the top of the sine wave, and then decreases from high to low. The direct current high voltage (HV) is transmitted from the switching transistor of the IGBT-M1 to the energy storage and filter network composed of the inductor Li and the capacitor C12. The energy storage and filter network composed of the inductor L1 and the capacitor C12 converts switching pulse sent by the IGBT-M1 into a negative half-cycle sine wave waveform.

Further, SPWM pulse sent by the switching transistor is smoothed to form the sine wave through the energy storage and filter network composed of the inductor L1 and the capacitor C12, and output through a pin L-OUT and a pin N-OUT.

Further, an output voltage feedback loop composed of a resistor R38, a resistor R39, a resistor R40, a resistor R41 and a capacitor C25 measures an output voltage and sends the output voltage to a main control chip in time. The main control chip adjusts a duty cycle according to the voltage to adjust the output voltage, so as to keep the output voltage stable.

Further, an output current detection circuit composed of a resistor R30, a resistor R31, a resistor R32, a resistor R27 and a capacitor C24 measures an output current and detects output short circuit. If the output current is too great or short circuit is detected, output is closed in time to protect circuit safety.

Further, a touch switch circuit is composed of a chip U8 and its subsidiary circuit. Working states of the main control chip include output opening and output closing.

Further, a fan control circuit is composed of a resistor R29, a resistor R35, an optical coupler P2 and an MOS transistor M6. When a temperature is too high, the main control chip outputs a high level to drive the optical coupler P2 to control a fan F2 to work.

Further, an NTC temperature measurement circuit is composed of a resistor R17, a resistor R18, a resistor R15 and a capacitor C14. The resistor R17 is an NTC temperature measurement resistor, with resistance decreasing with temperature change. When the main control chip detects high temperature, the main control chip outputs a high level to drive the fan F2 to work for heat dissipation. When the temperature exceeds a rated limit, circuit output is closed to form over-temperature protection.

Further, a ICl power supply circuit is composed of an MOS transistor M5 and a chip U1. Power is taken from a pin VCC of a power main control chip U2 of a USB charging module 10 and stepped down to DC12V and DC5V to supply power to a control circuit and a drive circuit of the main control chip, respectively.

In the above solution, the present disclosure directly rectifies and filters an input AC voltage (110 V to 250 V), and then adjust a duty cycle to change the voltage into a 100 V to 130 V alternating current voltage through a circuit composed of the IGBT-M1, the IGBT-M2, the IGBT-M3, the IGBT-M4, the inductor L1 and the capacitor C12 so as to be output. In this way, the input 200 V to 250 V voltage does not need to be reduced and then changed into the 100 V to 130 V alternating current voltage through the circuit composed of the IGBT-M1, the IGBT-M2, the IGBT-M3, the IGBT-M4, the inductor L1 and the capacitor C12. Thus, a step- down circuit is omitted, such that the circuit is simpler and loss is less.

In addition, the solution to achieve the objective is not limited to an unipolar adjustment circuit in the above circuit, and further includes a bipolar adjustment circuit. For example, bipolar adjustment is to cause two pairs of transistors to be simultaneously driven by an SPWM waveform. For example, when the IGBT-M2 and the IGBT-M3 work, the IGBT-M2 and the IGBT-M3 are driven by complementary 20 KHz SPWM switching waveforms to work. It does not indicate that the IGBT-M2 is driven by a 20 KHz waveform and the IGBT-M3 is turned on. The inductor L1 is composed of two inductors or an inductor consisting of two mutual inductance coils wound around the same magnetic core. A voltage detection circuit also has two channels.

Clearly, what are described above are merely specific embodiments of the present disclosure, and are not intended to limit the implementation scope of the present disclosure. All equivalent changes or modifications made in accordance to the structures, features and principles within the application scope of the present disclosure shall fall within the application scope of the present disclosure.

1. A step-down type pure sine wave voltage conversion socket, comprising an alternating current (AC) input module (1) configured to receive and feed alternating current mains electricity to a rectifier and filter module (2), to rectify and filter the alternating current mains electricity into direct current; and
further comprising a main control unit (3), an inverter bridge module (4), and a voltage and current feedback module (5), wherein the main control unit (3) generates a sinusoidal pulse width modulation (SPWM) signal to control an on-off state and a duty cycle of the inverter bridge module (4), so as to cause the inverter bridge module (4) to convert the direct current of the rectifier and filter module (2) into pulse voltage and output the pulse voltage to an energy storage and filter module (6);
the inverter bridge module (4) comprises a plurality of switching transistors, an input end of the inverter bridge module (4) is connected to the rectifier and filter module (2), an output end of the inverter bridge module (4) is connected to the energy storage and filter module (6), an input end of the energy storage and filter module (6) is connected to the inverter bridge module (4), and the energy storage and filter module (6) is configured to filter the pulse voltage into pure sine wave alternating current voltage and output the pure sine wave alternating current voltage through an AC terminal; and
the voltage and current feedback module (5) is connected to an output end of the energy storage and filter module (6), and is configured to detect output voltage and current and transmit a feedback signal to the main control unit (3), and the main control unit (3) adjusts the SPWM signal according to a feedback voltage and current signal, to stably output sine wave voltage.

2. The step-down type pure sine wave voltage conversion socket according to claim 1, wherein the plurality of switching transistors are any kind of bipolar junction transistors, metal-oxide semiconductor (MOS) transistors, insulated gate bipolar transistors (IGBTs), gallium nitride MOSs, and silicon carbide MOSs.

3. The step-down type pure sine wave voltage conversion socket according to claim 2, wherein the inverter bridge module (4) comprises a MOS transistor M1, a MOS transistor M2, a MOS transistor M3, and a MOS transistor M4, a gate (G) electrode of each of the MOS transistors is connected to a driver chip of the main control unit (3) through a peripheral driver unit, after a main control chip of the main control unit (3) sends the sinusoidal pulse width modulation (SPWM) signal, the four MOS transistors are driven to work to generate a sinusoidal pulse width modulation pulse voltage, and the sinusoidal pulse width modulation pulse voltage is filtered by the energy storage and filter module (6) connected to the output end into the pure sine wave alternating current voltage.

4. The step-down type pure sine wave voltage conversion socket according to claim 2, wherein the inverter bridge module (4) comprises IGBT-M1, IGBT-M2, IGBT-M3, and IGBT-M4, a gate (G) electrode of each of the IGBTs is connected to a driver chip of the main control unit (3) through a peripheral driver unit, after a main control chip of the main control unit (3) sends the sinusoidal pulse width modulation (SPWM) signal, the four IGBTs are driven to work to generate a sinusoidal pulse width modulation pulse voltage, and the sinusoidal pulse width modulation pulse voltage is filtered by the energy storage and filter module (6) connected to the output end into the pure sine wave alternating current voltage.

5. The step-down type pure sine wave voltage conversion socket according to claim 4, wherein the peripheral driver unit comprises a first driver module (43) connecting the IGBT-M1 to the energy storage and filter module (6), a second driver module (44) connecting the IGBT-M2 to the energy storage and filter module (6), a third driver module (45) connecting the IGBT-M3 to the energy storage and filter module (6), and a fourth driver module (46) connecting the IGBT-M4 to the energy storage and filter module (6).

6. The step-down type pure sine wave voltage conversion socket according to claim 5, wherein the first driver module (43) comprises a resistor R3, a diode D1, and a resistor R9 that are connected in parallel to the G electrode of the IGBT-M1, the other ends of the resistor R3 and the diode D1 are connected to a pin HO-1 of the main control unit (3), the resistor R9 and a source (S) electrode of the IGBT-M1 are connected to a pin N-OUT of the energy storage and filter module (6) and a drain (D) electrode of the IGBT-M3, a D electrode of the IGBT-M1 is connected to the rectifier and filter module (2), the third driver module (45) has an identical structure to the first driver module (43), and the third driver module (45) is connected to a pin LO-1 of the main control unit (3).

7. The step-down type pure sine wave voltage conversion socket according to claim 5, wherein the second driver module (44) comprises a resistor R7 and a resistor R8 that are connected in series between the G electrode of the IGBT-M1 and a pin HO-2 of the main control unit (3), a diode D4 connected in parallel to the resistor R8, and a resistor R12 connected between the G electrode of the IGBT-M1 and a pin VS2 of the main control unit (3), a drain (D) electrode of the IGBT-M2 is connected to the rectifier and filter module (2), a source (S) electrode of the IGBT-M2 is connected to the pin VS2 of the main control unit (3), an inductor L1 of the energy storage and filter module (6), and a D electrode of the IGBT-M4, the fourth driver module (46) has an identical structure to the second driver module (44), and the fourth driver module (46) is connected to a pin LO-1 of the main control unit (3).

8. The step-down type pure sine wave voltage conversion socket according to claim 4, wherein the energy storage and filter module (6) comprises an inductor L1 and a capacitor C12 that are connected to the inverter bridge module (4) and the AC terminal, and is configured to filter the sinusoidal pulse width modulation pulse voltage generated by the inverter bridge module (4) into the pure sine wave alternating current voltage.

9. The step-down type pure sine wave voltage conversion socket according to claim 4, further comprising a direct current (DC) power supply circuit (7) and a universal serial bus (USB) charging module (10), wherein the DC power supply circuit (7) comprises DC12V and DC5V, the DC12V is configured to supply power to the driver chip of the main control unit (3), and the DC5V is configured to supply power to the main control chip of the main control unit (3).

10. The step-down type pure sine wave voltage conversion socket according to claim 9, wherein the USB charging module (10) comprises a fuse F3, a power main control chip U2, a transformer TI, a power controller U6, a synchronous step-down converter U9, a first USB unit (101), a second USB unit (102), a third USB unit (103), and a fourth USB unit (104), the fuse F3 is connected to the rectifier and filter module (2), the DC power supply circuit (7) is connected to a pin VCC of the power main control chip U2, and the first USB unit (101) and the second USB unit (102) are TYPE-C output interfaces.

11. The step-down type pure sine wave voltage conversion socket according to claim 9, wherein the DC power supply circuit (7) comprises a MOS transistor M5 and a chip U1 that are connected in series to the USB charging module (10) and the main control unit (3), a capacitor C9 connected between a pin IN and a pin GND of the chip U1, a capacitor C17 connected between a pin OUT and the pin GND of the chip U1, a capacitor C19 connected between a drain (D) electrode and a G electrode of the MOS transistor M5, and a capacitor C20 and a capacitor C16 that are connected in parallel to a source (S) electrode and the G electrode of the MOS transistor M5, the S electrode of the MOS transistor M5 is connected to the pin IN of the chip U1 and connected to +12 V voltage, the D electrode of the MOS transistor M5 is connected to a pin VCC of the USB charging module (10), the G electrode of the MOS transistor M5 is connected to a pin HGND, the pin GND of the chip U1 is connected to the pin HGND, the pin OUT of the chip U1 is connected to AC-5V, the DC12V is configured to supply power to the driver chip of the main control unit (3), and the DC5V is configured to supply power to the main control chip of the main control unit (3).

12. The step-down type pure sine wave voltage conversion socket according to claim 4, further comprising a negative temperature coefficient (NTC) temperature measurement circuit (8), wherein the NTC temperature measurement circuit comprises a capacitor C14, a capacitor C15, a resistor R15, a resistor R17, and a resistor R18, the resistor R17 is an NTC temperature measurement resistor and is connected to a pin AC-5V, the resistor R15, the capacitor C14 and the resistor R18 are connected in parallel to one end of the resistor R17, the capacitor C15 is connected between the capacitor C14, the resistor R15 and the resistor R18, one end of the capacitor C15 is connected to a pin TFB of the main control chip, and the other end of the capacitor C15 is connected to a pin HGND.

13. The step-down type pure sine wave voltage conversion socket according to claim 4, further comprising a touch module (9), wherein the touch module (9) outputs high and low levels to control the main control unit (3) to be turned on and off, when a device is in an off state, a touch switch is touched, a touch integrated circuit (IC) sends a high level to the main control unit (3), and the main control unit (3) generates output of the sinusoidal pulse width modulation (SPWM) signal to drive an inverter bridge module (4) to work, so as to cause an output AC socket to generate alternating current voltage output; and the touch switch is re-touched, the touch IC sends a low level to the main control unit (3), the main control unit (3) disables the sinusoidal pulse width modulation (SPWM) signal, the inverter bridge module (4) stops working, and the output AC socket generates no output voltage.

14. The step-down type pure sine wave voltage conversion socket according to claim 4, wherein the voltage and current feedback module (5) comprises an output voltage detection module (51) connected to the energy storage and filter module (6) and an output current detection module (52) connected to the inverter bridge module (4).

15. The step-down type pure sine wave voltage conversion socket according to claim 14, wherein the output voltage detection module (51) comprises a resistor R38, a resistor R39 and a resistor R40 that are connected in series to a pin L-OUT, and a resistor R41 and a capacitor C25 that are connected in parallel to the resistor R40, and the other ends of the resistor R40, the resistor R41 and the capacitor C25 are connected to the main control unit (3).

16. The step-down type pure sine wave voltage conversion socket according to claim 14, wherein the output current detection module (52) comprises a resistor R30, a resistor R31, a resistor R32 and a resistor R27 that are connected in parallel to a source (S) electrode of the IGBT-M3 and an S electrode of the IGBT-M4, and a capacitor C24 and a resistor R25 that are connected in parallel to the resistor R27.

17. The step-down type pure sine wave voltage conversion socket according to claim 4, wherein the main control unit (3) further comprises a fan control module (30), the fan control module (30) comprises a resistor R29, a resistor R35, a resistor R66, a resistor R67, an optical coupler P2, an MOS transistor M6, and a fan F2, a resistor R44 and a resistor R46 are connected in series to a pin FANCTR of the main control chip, one end of the resistor R46 is connected to a pin HGND, and an optical coupler P2B is connected in parallel to the resistor R35.

18. The step-down type pure sine wave voltage conversion socket according to claim 17, wherein a drain (D) electrode of the MOS transistor M6 and an optical coupler P2A are connected to two ends of the fan F2, respectively, the resistor R66 is connected between a G electrode of the MOS transistor M6 and the optical coupler P2A, the resistor R67 is connected to the G electrode of the MOS transistor M6 and grounded, and an S electrode of the MOS transistor M6 is grounded.
